(19) United States
(12) Patent Application Publication
(10) Pub. No.: US 2015/0160514 A1
(43) Pub. Date: Jun. 11, 2015

(54) BACKLIGHT ASSEMBLY AND DISPLAY DEVICE HAVING THE SAME

(71) Applicant: Samsung Display Co., Ltd., Yongin-City (KR)

(72) Inventors: Seung Hwa HA, Namyangju-si (KR); Sang Won LEE, Seoul (KR); Min Young SONG, Asan-si (KR)

(73) Assignee: Samsung Display Co., Ltd., Yongin-City (KR)

(21) Appl. No.: 14/255,686

(22) Filed: Apr. 17, 2014

(30) Foreign Application Priority Data
Dec. 11, 2013 (KR) 10-2013-0153941

(51) Int. Cl. G02F 1/1335

(52) U.S. Cl. CPC G02F 1/133609; G02F 1/133603; G02F 1/133605

(57) ABSTRACT

Provided are a backlight assembly and a display device having the same. The backlight assembly includes a light source unit comprising a plurality of light sources, and a reflective member disposed adjacent to an edge portion of the light source unit. The reflective member includes a base layer, and a plurality of protruding patterns disposed on the base layer and facing the light source unit.

This application claims priority from Korean Patent Application No. 10-2013-0153941 filed on Dec. 11, 2013 in the Korean Intellectual Property Office, the disclosure of which is incorporated herein by reference in its entirety.

### BACKGROUND

1. Technical Field

The present disclosure relates to a backlight assembly and a display device having the same.

2. Description of the Related Art

Display devices are devices that visually display data. Examples of display devices include liquid crystal displays (LCDs), electrophoretic displays, organic light-emitting displays, inorganic electroluminescent (EL) displays, field emission displays, surface-conduction electron-emitter displays, plasma displays, and cathode ray displays.

An LCD is widely used as a display device. An LCD typically includes a liquid crystal layer interposed between two transparent substrates. A desired image is displayed on the LCD by controlling the light transmittance of each pixel according to the driving/alignment of the liquid crystal layer.

Since the liquid crystals in the liquid crystal layer are not self-emitting, a light source unit is installed in the LCD. Image contrast is realized by controlling the intensity of light passing through the liquid crystals in each pixel of the LCD. The light source unit usually forms part of a backlight assembly, which determines image quality (such as luminance and uniformity) of the LCD.

The backlight assembly typically includes the light source unit, a reflective plate, a diffusion plate, a light guide plate, and various optical sheets. Backlight assemblies can be generally classified into two types (direct-type or edge-type) depending on the position of the light source unit. In a direct-type backlight assembly, the light source is disposed facing a lower surface of the diffusion plate. In an edge-type backlight assembly, the light source unit is disposed facing a side of the light guide plate.

Currently, direct-type backlight assemblies are widely used to provide a stable source of light to a large display panel. To achieve high color reproducibility, two types of light sources capable of emitting light of different colors are often used to form the light source unit of a direct-type backlight assembly.

Since the light source unit of a direct-type backlight assembly includes two types of light sources emitting light of two different colors, the light of the two different colors should be mixed uniformly in the light source unit before providing the light to a display panel, so as to prevent color stains in the displayed image.

The two types of light sources in the direct-type backlight assembly may include a light source of a first type surrounded by light sources of a second type at a central portion of the light source unit. As such, light of two different colors emitted from the two types of light sources can be mixed properly. Accordingly, white light can be generated in the central portion of the light source unit and provided to the display panel via a diffusion plate and optical sheets.

However, in some instances, the light source of the first type may not be completely surrounded by the light sources of the second type at an edge portion of the light source unit, because a reflective plate or a sidewall of a bottom chassis may be located adjacent to the light sources at the edge portion of the light source unit. Therefore, light of the two different colors cannot be properly mixed at the central portion of the light source unit. Subsequently, light of each color is delivered separately to the display panel, which results in a color stain (in which the two different colors are observed) at the edge portion of the display panel.

### SUMMARY

According to some embodiments of the inventive concept, a backlight assembly is provided. The backlight assembly includes a light source unit comprising a plurality of light sources, and a reflective member disposed adjacent to an edge portion of the light source unit. The reflective member includes a base layer, and a plurality of protruding patterns disposed on the base layer and facing the light source unit.

In some embodiments, the protruding patterns may be disposed corresponding to a plurality of light sources located at the edge portion of the light source unit.

In some embodiments, the light sources may include a first light source and a second light source, wherein light of a first color may be emitted from the first light source and light of a second color may be emitted from the second light source, and the first and second colors may be complementary colors.

In some embodiments, the first light source may emit magenta light and the second light source may emit green light.

In some embodiments, the base layer may include a first area facing the first light source and a second area facing the second light source, and wherein a protruding distance of each of the protruding patterns may be reduced toward a boundary portion between the first area and the second area.

In some embodiments, each of the protruding patterns may have a maximum protruding distance in a central portion of each of the first area and the second area.

In some embodiments, the protruding patterns may protrude toward respective centers of the light sources corresponding to the protruding patterns.

In some embodiments, the protruding patterns may include a reflective material.

In some embodiments, the reflective member may further include a capping pattern disposed on a tip portion of each of the protruding patterns, and wherein the protruding patterns may include a transparent material and the capping pattern may include a reflective material.

In some embodiments, the capping pattern may expose at least part of the tip portion of each of the protruding patterns.

In some embodiments, the reflective member may further include a plurality of uneven patterns disposed on each of the protruding patterns, and wherein the uneven patterns may cover a surface of each of the protruding patterns.

In some embodiments, the light source unit may further include a circuit board on which the light sources are mounted, and wherein the protruding distance of each of the protruding patterns may be reduced toward the circuit board.

In some embodiments, the backlight assembly may further include a diffusion plate disposed on the light source unit, and wherein the protruding distance of each of the protruding patterns may be reduced toward the diffusion plate.

In some embodiments, the backlight assembly may further include a housing for supporting the light source unit and the reflective member, the housing comprising a sloping sidewall, and wherein the reflective member may be disposed on an inner surface of the sloping sidewall and slopes according to the sloping sidewall.

According to some other embodiments of the inventive concept, a backlight assembly is provided. The backlight assembly includes a light source unit comprising a plurality of light sources, wherein the plurality of light sources comprise a first light source emitting light of a first color and a second light source emitting light of a second color, wherein the first and second colors are different. The backlight assembly further includes a reflective member disposed adjacent to an edge portion of the light source unit, wherein the reflective member includes a base layer comprising a first area facing the first light source and a second area facing the second light source, and a plurality of protruding patterns disposed on the base layer, wherein a protruding distance of each of the protruding patterns is reduced toward a boundary portion between the first area and the second area.

In some embodiments, the first color and the second color may be complementary colors.

In some embodiments, each of the protruding patterns may have a maximum protruding distance in a central portion of each of the first area and the second area.

According to some further embodiments of the inventive concept, a display device is provided. The display device includes a display panel for displaying an image, and a backlight assembly for providing light to the display panel, wherein the backlight assembly includes a light source unit comprising a plurality of light sources, and a reflective member disposed adjacent to an edge portion of the light source unit. The reflective member includes a base layer, and a plurality of protruding patterns disposed on the base layer and facing the light source unit.

In some embodiments, the protruding patterns may be disposed corresponding to a plurality of light sources located at the edge portion of the light source unit.

In some embodiments, the light sources may include a first light source and a second light source, wherein light of a first color may be emitted from the first light source and light of a second color may be emitted from the second light source, and the first and second colors may be complementary colors.

### BRIEF DESCRIPTION OF THE DRAWINGS

The above and other aspects and features of the inventive concept will be apparent when described in detail with reference to the attached drawings.

FIG. 1 is an exploded perspective view of a display device according to an embodiment of the inventive concept.

FIG. 2 is a plan view of a light-emitting area of the light source unit in the display device of FIG. 1.

FIG. 3 is a plan view of the light source unit and the reflective member in the display device of FIG. 1.

FIG. 4 is an enlarged plan view of the portion IV of FIG. 3.

FIG. 5 is a cross-sectional view taken along the line V-V′ of FIG. 4.

FIG. 6 is a perspective view of the reflective member of FIG. 4.

FIGS. 7 through 15 are perspective views of reflective members according to other embodiments of the inventive concept.

FIG. 16 is a plan view of a backlight assembly according to another embodiment of the inventive concept.

FIG. 17 is a cross-sectional view taken along the line XVII-XVII′ of FIG. 16.

FIG. 18 is a plan view of a backlight assembly according to another embodiment of the inventive concept.

FIG. 19 is a cross-sectional view taken along the line XIX-XIX′ of FIG. 18.

FIG. 20 is a plan view as seen from above an optical sheet of a display device employing the reflective member according to an embodiment of the inventive concept.

FIG. 21 is a graph comparing the Y color coordinates in a portion A-B of FIG. 20 with and without the reflective member of FIG. 6.

### DETAILED DESCRIPTION

The various aspects and features of the inventive concept will be apparent with reference to the following embodiments described in the specification. However, it should be noted that the inventive concept is not limited to the embodiments disclosed herein. Those of ordinary skill in the art would recognize that the inventive concept can be implemented in many different ways.

In the drawings, the thicknesses of layers, films, panels, regions, etc., may be exaggerated for clarity. It will be understood that when a layer or element is referred to as being “on” another layer or element, it can be disposed directly on the other layer or element, or with one or more intervening layers or elements being present. Like reference numerals designate like elements throughout the specification.

Although the terms “first,” “second,” and so forth are used to describe constituent elements, the constituent elements are not limited by those terms. Instead, the terms are merely used to distinguish a constituent element from other constituent elements. Accordingly, in the following description, a first constituent element may also correspond to a second constituent element in other contexts.

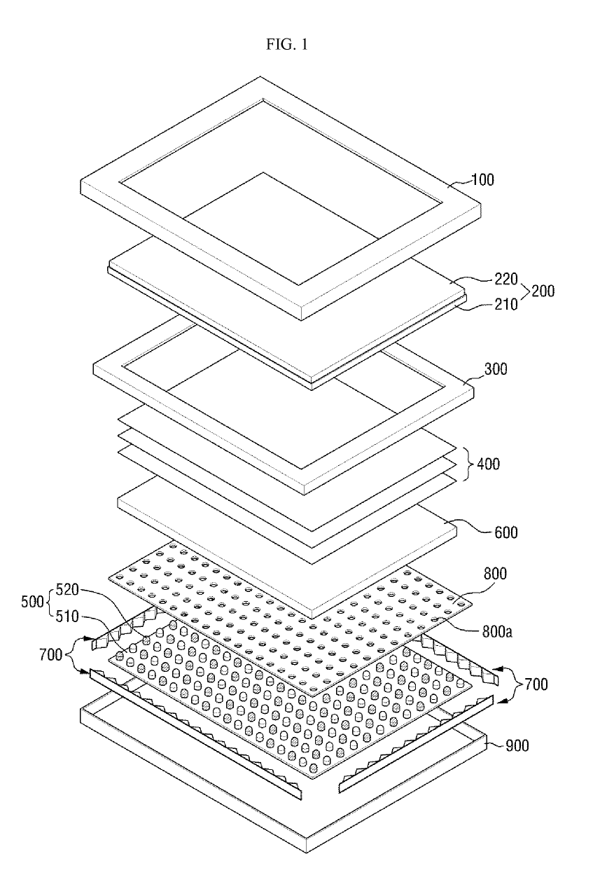

FIG. 1 is an exploded perspective view of a display device according to an embodiment of the inventive concept. Referring to FIG. 1, the display device includes a display panel 200. In some embodiments, the display device may further include a top chassis 100 and a bottom chassis 900.

The display panel 200 is configured to display images. The display panel 200 may include a liquid crystal display (LCD) panel, an electrophoretic display panel, an organic light-emitting diode (OLED) panel, a light-emitting diode (LED) panel, an inorganic electroluminescent (EL) display panel, a field emission display (FED) panel, a surface-conduction electron-emitter display (SED) panel, a plasma display panel (PDP), or a cathode ray tube (CRT) display panel. The inventive concept will be herein described with reference to a LCD. For example, the display panel 200 may be formed of a LCD panel. Nevertheless, it should be noted that the inventive concept is not limited to a LCD panel. Instead, those skilled in the art would recognize that the inventive concept can also be applied to other types of display devices and display panels.

The display panel 200 may include a display area (where images are displayed) and a non-display area (where no images are displayed). In addition, the display panel 200 may include a first substrate 210, a second substrate 220 disposed facing the first substrate 210, and a liquid crystal layer (not shown) interposed between the first substrate 210 and the second substrate 220.

Each of the first substrate 210 and the second substrate 220 may be shaped like a rectangular parallelepiped (for example, as illustrated in FIG. 1). Nevertheless, it should be noted that the first substrate 210 and the second substrate 220 can be formed in various shapes depending on the shape of the display panel 200.

As previously described, the liquid crystal layer may be interposed between the first substrate 210 and the second substrate 220. In addition, a sealing member (such as a sealant) may be interposed between the first substrate 210 and the second substrate 220 along edges of the first substrate 210 and the second substrate 220, so as to bond the first substrate 210 and the second substrate 220 together.

Although not shown in FIG. 1, the display panel 200 may include a driver and a flexible circuit board attached to the first substrate 210 or the second substrate 220. The driver may be configured to transmit various signals (such as driving signals) for displaying an image in the display area. The flexible circuit board may be configured to output various signals to the driver.

Referring to FIG. 1, the display device further includes a backlight assembly disposed under the display panel 200. The backlight assembly may be configured to provide light to the display panel 200. The backlight assembly may include a light source unit 500 and a reflective member 700. In some embodiments, the backlight assembly may further include a diffusion plate 600, an optical sheet 400, a reflective plate 800, and a mold frame 300.

The light source unit 500 may be disposed under the diffusion plate 600. Specifically, the light source unit 500 may be interposed between the bottom chassis 900 and the diffusion plate 600. That is, the backlight assembly according to the embodiment illustrated in FIG. 1 may correspond to a direct-type backlight assembly. Accordingly, the light source unit 500 may be overlapped by the display area of the display panel 200. The light source unit 500 may generate light which is then irradiated onto the diffusion plate 600.

As shown in FIG. 1, the light source unit 500 may include a circuit board 510 and a plurality of light sources 520.

The circuit board 510 may be interposed between the diffusion plate 600 and the bottom chassis 900. The circuit board 510 may be configured to apply voltages and various signals to the light sources 520. The circuit board 510 may be shaped like a rectangular parallelepiped plate. The circuit board 510 may be connected to the flexible circuit board so as to receive, e.g., a dimming signal from the driver.

The light sources 520 may be mounted on the circuit board 510. Each of the light sources 520 may generate light in response to a voltage received from an external source.

The light sources 520 may lie in a same plane. In an exemplary embodiment, the light sources 520 may lie in a plane parallel to a lower surface of the diffusion plate 600. Each of the light sources 520 may include a light-emitting diode (LED). However, the light sources 520 are not limited to LEDs, and may include any element capable of emitting light. In an exemplary embodiment, the light sources 520 may be arranged in a matrix form. However, it should be noted that the light sources 520 need not be arranged in a matrix form. For example, the light sources 520 may be arranged in different configurations depending on the shape of the display panel 200.

The reflective member 700 may reflect light incident from the light source unit 500 toward the inside of the backlight assembly. The reflective member 700 may be disposed adjacent to the edges of the light source unit 500. In an exemplary embodiment, the reflective member 700 may be disposed along the edges of the light source unit 500. In addition, the reflective member 700 may surround the edges of the light source unit 500.

The reflective member 700 may be provided as a plurality of reflective members 700. In an exemplary embodiment, if the circuit board 510 is shaped like a rectangular parallelepiped plate, the reflective members 700 may be disposed respectively at the four sides of the rectangular parallelepiped-shaped circuit board 510. However, the inventive concept is not limited thereto. For example, in some other embodiments, the reflective members 700 surrounding the light source unit 500 may be formed as a single piece.

The diffusion plate 600 may be disposed on the light source unit 500. Specifically, the diffusion plate 600 may be disposed between the light source unit 500 and the display panel 200. The diffusion plate 600 may improve the luminance uniformity of light incident from the light source unit 500.

The optical sheet 400 may be disposed on the diffusion plate 600. Specifically, the optical sheet 400 may be disposed between the display panel 200 and the diffusion plate 600. The optical sheet 400 may modulate optical characteristics of light passing through the diffusion plate 600 after the light has been emitted from the light source unit 500. The optical sheet 400 may be provided as a plurality of optical sheets 400 having different functions. For example, the optical sheets 400 may include a prism sheet, etc. The optical sheets 400 may be stacked so as to overlap and complement each other.

The reflective plate 800 may be disposed under the diffusion plate 600. Specifically, the reflective plate 800 may be interposed between the diffusion plate 600 and the light source unit 500. The reflective plate 800 may change the path of light propagating towards the bottom chassis 900 (after the light has been emitted from the light source unit 500), so as to direct the light toward the diffusion plate 600.

The reflective plate 800 may include a plurality of insertion holes 800a. The insertion holes 800a may be disposed corresponding to the respective light sources 520. That is, the light sources 520 may be inserted into the corresponding insertion holes 800a.

The mold frame 300 may be disposed between the display panel 200 and the optical sheet 400. The mold frame 300 may be attached to the bottom chassis 900, so as to fix (hold together) the optical sheet 400, the light source unit 500, the diffusion plate 600, the reflective member 700, and the reflective plate 800. In addition, the mold frame 300 may contact an edge portion of the display panel 200, so as to support and fix the display panel 200.

The top chassis 100 may cover the edges of the display panel 200, and surround side surfaces of the display panel 200 and the backlight assembly. The bottom chassis 900 may house the backlight assembly. The top chassis 100 and the bottom chassis 900 may be attached together so as to surround the display panel 200 and the backlight assembly. The top chassis 100 and the bottom chassis 900 may be formed of a conductive material (e.g., a metal).

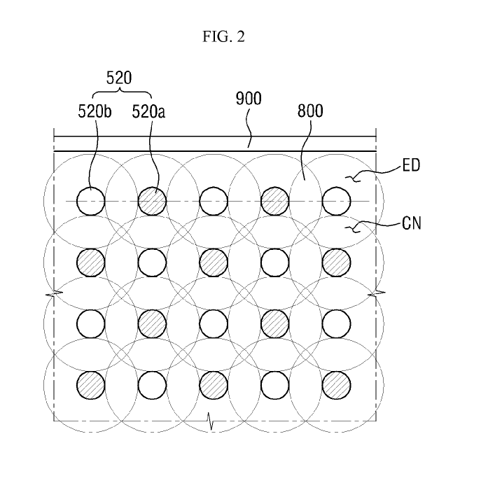

Next, the light source unit 500 of the backlight assembly according to the inventive concept will be described in greater detail with reference to FIG. 2. FIG. 2 is a plan view of a light-emitting area of the light source unit 500 in the display device of FIG. 1.

Referring to FIG. 2, the light sources 520 of the light source unit 500 may include a plurality of first light sources 520a emitting light of a first color and a plurality of second light sources 520b emitting light of a second color. The first and second colors may be different. Also, the first color (of light emitted from the first light sources 520a) and the second color (of light emitted from the second light sources 520b) may complement each other. For example, in an exemplary embodiment, the first light sources 520a may emit magenta light, and the second light sources 520b may emit green light. However, the inventive concept is not limited thereto.

The first light sources 520a and the second light sources 520b may be arranged alternately in row and column directions. As such, the first light sources 520a and the second light sources 520b may be arranged diagonally, as illustrated in FIG. 2. The light source unit 500 may include a central portion CN and an edge portion ED surrounding the central portion CN.

Each of the first light sources 520a located in the central portion CN of the light source unit 500 may be surrounded by a plurality of second light sources 520b. Likewise, each of the second light sources 520b located in the central portion CN of the light source unit 500 may be surrounded by a plurality of first light sources 520a. Accordingly, light of the first and second colors (emitted from the first and second light sources 520a and 520b, respectively) can be mixed properly. Since the first color and the second color are complementary, the mixture of light of the two colors may produce white light. The white light may then be provided to the display panel 200 via the diffusion plate 600 and the optical sheet 400.

In some particular instances, each of the first light sources 520a located at the edge portion ED of the light source unit 500 may not be completely surrounded by a plurality of second light sources 520b. Likewise, each of the second light sources 520b located at the edge portion ED of the light source unit 500 may not be completely surrounded by a plurality of first light sources 520a. This is because a sidewall of the bottom chassis 900 adjacent to the first and second light sources 520a and 520b may be located at the edge portion ED of the light source unit 500, thereby preventing the light sources 520 from completely surrounding each other. As a result, light of the first and second colors (emitted from the first and second light sources 520a and 520b, respectively) cannot be properly mixed at the central portion CN of the light source unit 500. Accordingly, light emitted from the first light sources 520a and light emitted from the second light sources 520b may be delivered separately to the display panel 200, thereby causing a color stain (in which the first and second colors are separately observed) at the edge portion of the display panel 200.

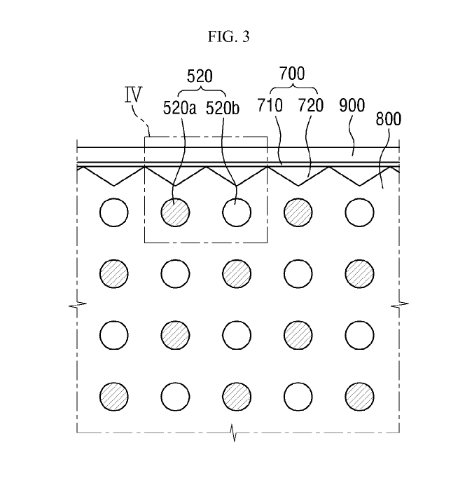

The inventive concept can address the above issues relating to color stains. Specifically, the inventive concept can prevent color stains from occurring, by disposing the reflective member 700 at the edge portion ED of the light source unit 500, as described in more detail with reference to FIG. 3.

FIG. 3 is a plan view of the light source unit 500 and the reflective member 700 in the display device of FIG. 1. Referring to FIG. 3, the reflective member 700 may be disposed adjacent to the edge portion ED of the light source unit 500. In an exemplary embodiment, the reflective member 700 may be disposed directly on an inner surface of a sidewall of the bottom chassis 900. That is, the reflective member 700 may be interposed between the light sources 520 and the sidewall of the bottom chassis 900.

The reflective member 700 may include a base layer 710 and a plurality of protruding patterns 720. The base layer 710 may directly contact the inner surface of the sidewall of the bottom chassis 900 and surround the edge portion ED of the light source unit 500. The protruding patterns 720 may be formed on a surface of the base layer 710 facing the light sources 520.

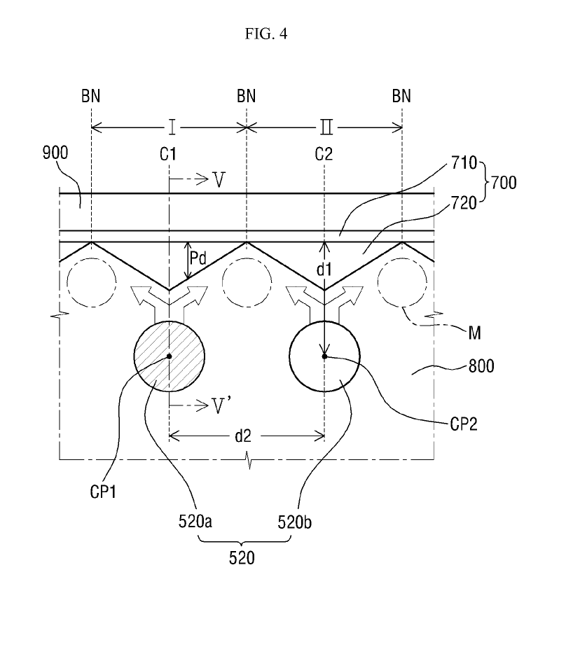

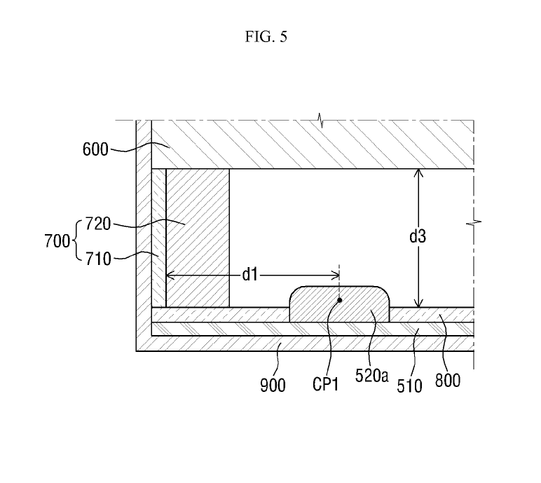

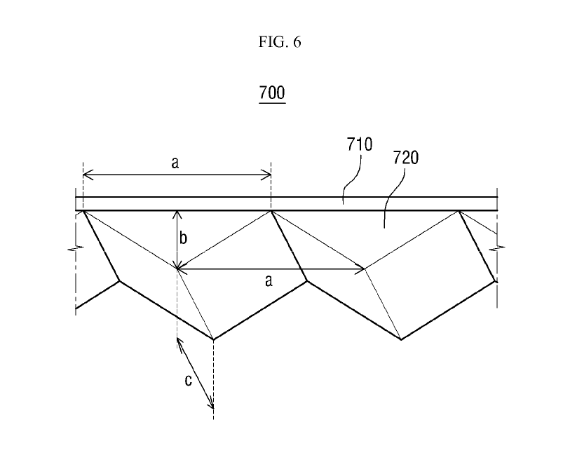

Next, the reflective member 700 located at the edge portion ED of the light source unit 500 will be described in greater detail with reference to FIGS. 4 through 6. FIG. 4 is an enlarged plan view of a portion IV of FIG. 3. FIG. 5 is a cross-sectional view taken along the line V-V′ of FIG. 4. FIG. 6 is a perspective view of the reflective member 700 of FIG. 4.

Referring to FIGS. 4 through 6, the base layer 710 may be disposed between a sidewall of the bottom chassis 900 and the protruding patterns 720. The base layer 710 may include a reflective material. In an exemplary embodiment, the base layer 710 may be formed of, but is not limited to, a metal such as aluminum (Al). In another exemplary embodiment, the base layer 710 may have diffuse reflectivity. However, the inventive concept is not limited thereto. For example, in some other embodiments, the base layer 710 may have specular reflectivity. In another exemplary embodiment, a surface of the base layer 710 facing the light sources 520 may have a fine uneven pattern. In another exemplary embodiment, the surface of the base layer 710 facing the light sources 520 may be plasma-treated.

The base layer 710 may include a first area I and a second area II. The first area I may face a first light source 520a, and the second area II may face a second light source 520b. The first area I may receive more light from the first light source 520a than the second light source 520b. The second area II may receive more light from the second light source 520b than the first light source 520a. In other words, more light emitted from the first light source 520a may reach the first area I (relative to the light emitted from the second light source 520b), and more light emitted from the second light source 520b may reach the second area II (relative to the light emitted from the first light source 520a).

The protruding patterns 720 may be disposed on the surface of the base layer 710 facing the light sources 520. The protruding patterns 720 may be disposed corresponding to the respective light sources 520 located at the edge portion ED of the light source unit 500. That is, a protruding pattern 720 may be formed above a light source 520 located at the edge portion ED of the light source unit 500. In an exemplary embodiment, the number of protruding patterns 720 may be equal to the number of light sources 520 adjacent to the base layer 710.

The protruding patterns 720 may be formed having various shapes. In the embodiment of FIG. 6, each of the protruding patterns 720 may be shaped like a triangular prism. However, the shape of each of the protruding patterns 720 is not limited to a triangular prism. In some other embodiments, each of the protruding patterns 720 may be shaped like a polyprism or a semi-circular pillar.

A protruding distance Pd of each of the protruding patterns 720 may be reduced toward a boundary portion between the first area I and the second area II. Specifically, the protruding distance Pd of each of the protruding patterns 720 may be zero at a boundary line BN between the first area I and the second area II. In other words, each of the protruding patterns 720 is not formed at the boundary line BN between the first area I and the second area II, as illustrated in FIG. 4. In some embodiments, the first light source 520a and the second light source 520b adjacent to the boundary line BN between the first area I and the second area II may be separated from the boundary line BN by equal distances.

The protruding distance Pd of each of the protruding patterns 720 may be at a maximum at the center of each of the first area I and the second area II. Specifically, a tip of each of the protruding patterns 720 may be formed on a first center line of the first area I or a second center line of the second area II.

The protruding patterns 720 may protrude toward the centers of the respective light sources 520 facing the protruding patterns 720. That is, a protruding pattern 720 located on the first area I of the base layer 710 may protrude toward a first central point CP1 of the first light source 520a, and a protruding pattern 720 located on the second area II of the base layer 710 may protrude toward a second central point CP2 of the second light source 520b.

A first imaginary line connects the first central point CP1 of the first light source 520a and a tip of the protruding pattern 720 facing the first light source 520a. In addition, a second imaginary line connects the second central point CP2 of the second light source 520b and a tip of the protruding pattern 720 facing the second light source 520b. The first and second imaginary lines may be perpendicular to the surface of the base layer 710 facing the light sources 520.

Referring to FIG. 4, the size of a protruding pattern 720 located on the first area I may be equal to the size of a protruding pattern 720 located on the second area II. In some other embodiments, the size of a protruding pattern 720 located on the first area I may be different from the size of a protruding pattern 720 located on the second area II. The size of a protruding pattern 720 may correspond to the area of the protruding pattern 720 or the average protruding distance of the protruding pattern 720. In an exemplary embodiment, if the luminance of the first light source 520a is substantially equal to the luminance of the second light source 520b, the size of the protruding pattern 720 located on the first area I may be substantially equal to the size of the protruding pattern 720 located on the second area II. In another exemplary embodiment, if the luminance of the first light source 520a is different from the luminance of the second light source 520b, the size of the protruding pattern 720 located on the first area I may be different from the size of the protruding pattern 720 located on the second area II. Specifically, if the luminance of the first light source 520a is higher than the luminance of the second light source 520b, the size of the protruding pattern 720 located on the first area I may be greater than the size of the protruding pattern 720 located on the second area II. On the contrary, if the luminance of the first light source 520a is lower than the luminance of the second light source 520b, the size of the protruding pattern 720 located on the first area I may be smaller than the size of the protruding pattern 720 located on the second area II.

The protruding patterns 720 may include a reflective material. In an exemplary embodiment, the protruding patterns 720 may be formed of, but are not limited to, a metal such as aluminum (Al). In another exemplary embodiment, the protruding patterns 720 may have diffuse reflectivity. However, the inventive concept is not limited thereto. For example, in some other embodiments, the protruding patterns 720 may have specular reflectivity. In another exemplary embodiment, a surface of the base layer 710 facing the light sources 520 may have a fine uneven pattern. In another exemplary embodiment, the surface of the base layer 710 facing the light sources 520 may be plasma-treated. In another exemplary embodiment, the protruding patterns 720 and the base layer 710 may be formed of a same material. In another exemplary embodiment, the protruding patterns 720 and the base layer 710 may be formed as a single body.

As previously mentioned, the reflective member 700 in the backlight assembly according to the inventive concept can prevent color stains from forming at the edge portion ED of the light source unit 500.

Next, a mechanism for preventing color stains will be described in detail with reference to FIGS. 4 to 6. For ease of description, it may be assumed that the first light source 520a is configured to emit magenta light and that the second light source 520b is configured to emit green light.

Magenta light is emitted from the first light source 520a located at the edge portion ED of the light source unit 500. The magenta light is reflected by an inclined surface of a protruding pattern 720 above the first light source 520a toward the boundary portion between the first area I and the second area II. Green light is emitted from the second light source 520a that is adjacent to the first light source 520a and located at the edge portion ED of the light source unit 500. The green light is reflected by an inclined surface of a protruding pattern 720 above the second light source 520b toward the boundary portion between the first area I and the second area II. The magenta light and the green light incident upon the boundary portion between the first area I and the second area II are mixed together, thereby generating white light. That is, the boundary portion between the first area I and the second area II constitutes a mixing area M where light of two different colors is mixed. Accordingly, light emitted from the first light source 520a and light emitted from the second light source 520b can be properly mixed at the edge portion ED of the light source unit 500 and the central portion CN of the light source unit 500, thereby preventing color stains from occurring at the edge portion ED of the light source unit 500.

Various factors may determine the size or shape of each of the protruding patterns 720. For example, if each of the light sources 520 includes a side-emitting lens instead of a top-emitting lens, the amount of light irradiated toward a side of the light source unit 500 (that is, toward the base layer 710) may increase. Accordingly, the area of each of the protruding patterns 720 may need to be increased in order to improve the efficiency of the color mixing. In addition, as a distance d1 (measured from each of the light sources 520 located at the edge portion ED of the light source unit 500 to the base layer 710) decreases, the amount of light reaching the base layer 710 increases. Therefore, a maximum protruding distance b of each of the protruding patterns 720 may need to be increased in order to increase the efficiency of the color mixing. Furthermore, as a distance d2 between two adjacent light sources 520 located at the edge portion ED of the light source unit 500 increases, the relative influence of light of any one color increases. To offset this imbalance in influence between light of two colors, a pitch a of adjacent protruding patterns 720 may be increased. In an exemplary embodiment, the distance d2 between two adjacent light sources 520 located at the edge portion ED of the light source unit 500 may be substantially equal to the pitch a of adjacent protruding patterns 720. In addition, as a distance d3 (measured from the reflective plate 800 to the diffusion plate 600) decreases, a space in which light of two different colors can be mixed decreases. Therefore, the area of each of the protruding patterns 720 may need to be increased to improve the efficiency of the color mixing. Specifically, as the distance d3 from the reflective plate 800 to the diffusion plate 600 decreases, a height c of each of the protruding patterns 720 decreases. However, the maximum protruding distance b of each of the protruding patterns 720 and/or the pitch a of adjacent protruding patterns 720 may be increased to increase the area of each of the protruding patterns 720.

In the backlight assembly according to the inventive concept, since the reflective member 700 including the protruding patterns 720 is placed at the edge portion ED of the light source unit 500, color stains can be prevented from occurring at the edge portion of the display panel 200.

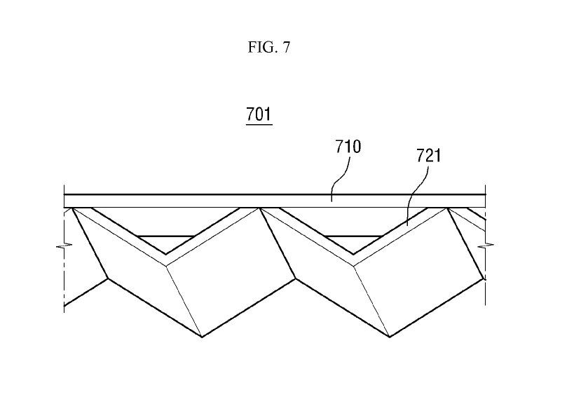

FIGS. 7 through 15 are perspective views of reflective members 701 through 709 according to other embodiments of the inventive concept. For convenience of description, elements substantially similar to those illustrated in the previously-described drawings are indicated by the same reference numerals, and thus a detailed description thereof will be omitted.

Referring to FIG. 7, each of a plurality of protruding patterns 721 of the reflective member 701 may include a hole therein. In an exemplary embodiment, a reflective sheet may be folded in a zigzag pattern and then attached to a surface of a base layer 710 facing the light sources 520. As a result, the protruding patterns 721 may be formed. If the protruding patterns 721 are formed by transforming the reflective sheet as described above, a hole may be formed between each of the protruding patterns 721 and the base layer 710.

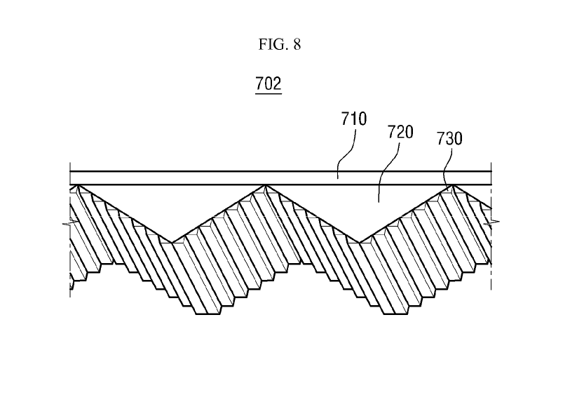

Referring to FIG. 8, the reflective member 702 may include a plurality of uneven patterns 730 located on a plurality of protruding patterns 720. The uneven patterns 730 may cover at least a portion of a surface of each of the protruding patterns 720. In an exemplary embodiment, the uneven patterns 730 may completely cover the surface of each of the protruding patterns 720.

The uneven patterns 730 may be shaped like regular sawteeth. However, the shape of the uneven patterns 730 is not limited to a regular sawteeth. For example, in some embodiments, the uneven patterns 730 may be shaped as irregular protrusions. In some other embodiments, the uneven patterns 730 may include a plurality of unit patterns, and a cross-sectional shape of each of the unit patterns may be a triangular shape. However, the cross-sectional shape of each of the unit patterns is not limited to a triangular shape. For example, in some other embodiments, the cross-sectional shape of each of the unit patterns may be a semi-circular or oval shape.

Although the reflective member 702 includes a reflective material, the protruding patterns 720 and the uneven patterns 730 need not include a reflective material. The protruding patterns 720 and the uneven patterns 730 may be formed of a transparent material. For example, the protruding patterns 720 and/or the uneven patterns 730 may be formed of polymethyl methacrylate. In some embodiments, the protruding patterns 720 and the uneven patterns 730 may have different refractive indices. Accordingly, light emitted from the light sources 520 may be reflected or refracted at the surfaces of the uneven patterns 730, or at the interfaces between the uneven patterns 730 and the protruding patterns 720. In this case, since the areas where the transparent protruding patterns 720 and the uneven patterns 730 are located are not seen as dark areas (by a viewer), the display area of the display panel 200 may increase (or a width of an area (e.g., a bezel) of the display panel 200 which is covered by the top chassis 100 may be reduced).

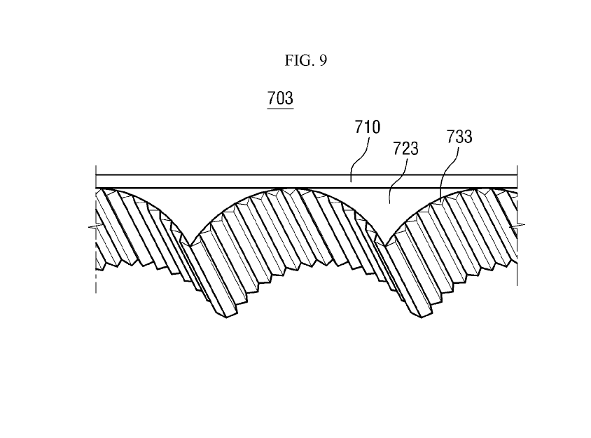

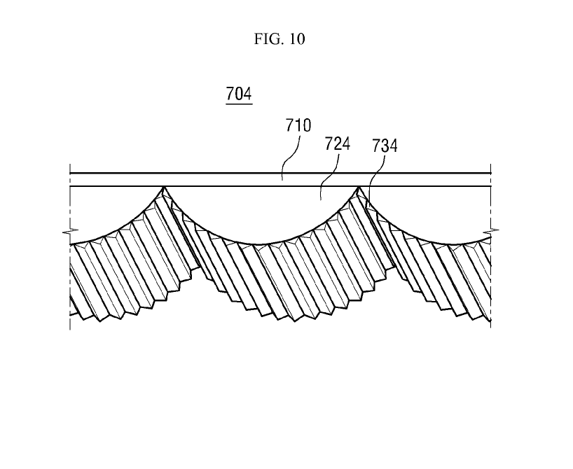

Referring to FIGS. 9 and 10, a plurality of protruding patterns 723 and 724 may be formed having different shapes from the previously-described embodiments. First, referring to FIG. 9, a slope of an inclined surface of each of the protruding patterns 723 of the reflective member 703 may be reduced from a tip of each of the protruding patterns 723 toward a surface of a base layer 710. Here, the slope may be measured from the surface of the base layer 710 facing the light sources 520. Accordingly, a plurality of uneven patterns 733 may be shaped according to the shape of each of the protruding patterns 723. Referring to FIG. 10, a slope of an inclined surface of each of the protruding patterns 724 of the reflective member 704 may increase from a tip of each of the protruding patterns 724 toward a surface of a base layer 710. In this case, each of the protruding patterns 724 may be shaped like a semi-circular pillar. Accordingly, a plurality of uneven patterns 734 may be shaped according to the shape of each of the protruding patterns 724.

The protruding patterns 723 or 724 can be modified into various shapes according to the intensity distribution of light emitted from the light sources 520 facing the protruding patterns 723 or 724.

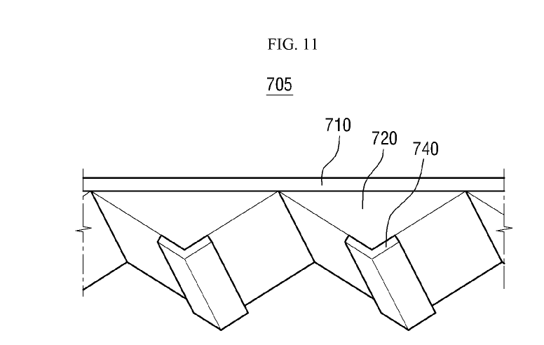

Referring to FIG. 11, the reflective member 705 may further include a capping pattern 740 disposed on a tip portion of each of a plurality of protruding patterns 720. Here, the tip portion of each of the protruding patterns 720 may be an area adjacent to a tip of each of the protruding patterns 720. In some particular embodiments, the capping pattern 740 is not disposed on a surface of each of the protruding patterns 720 adjacent to the tip portion of each of the protruding patterns 720.

The protruding patterns 720 and the capping patterns 740 may be formed of different materials. In an exemplary embodiment, the protruding patterns 720 may be formed of a transparent material, and the capping patterns 740 may be formed of a reflective material. In this case, the capping patterns 740 may be formed of a same material as a base layer 710. In addition, the capping patterns 740 may include a diffuse reflective sheet.

In an exemplary embodiment, the capping pattern 740 is disposed in portions (a central portion of the first area I and a central portion of the second area II) where the intensity of light emitted from each of the light sources 520 located at the edge portion ED is highest. Therefore, highly intense light emitted from each of the light sources 520 located at the edge portion ED can be diffused by the capping pattern 740 to the boundary portion between the first area I and the second area II. In addition, light emitted from the light sources 520 located at the edge portion ED may be mixed together above a portion of each of the protruding patterns 720 where the capping pattern 740 is not located. Here, since the protruding patterns 720 may be transparent, light emitted from each of the light sources 520 located at the edge portion ED is not only mixed above the protruding patterns 720 in the boundary portion between the first area I and the second area II, but is also mixed within each of the protruding patterns 720. That is, a mixing area M may be increased to further prevent the occurrence of color stains at the edge portion of the display device.

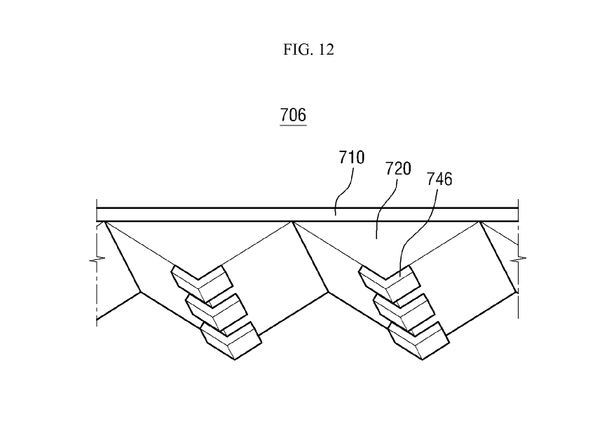

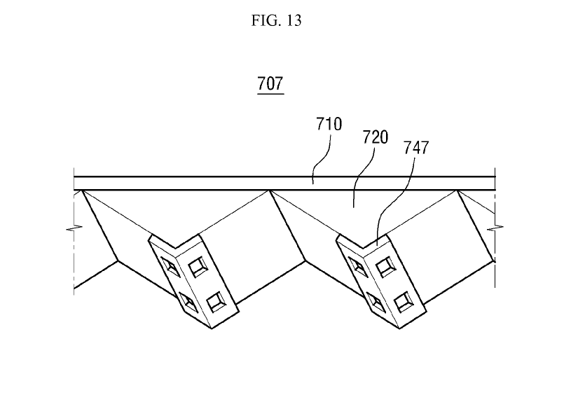

Referring to FIGS. 12 and 13, a capping pattern 746 or 747 located on a tip portion of each of a plurality of protruding patterns 720 may be patterned. That is, the capping pattern 746 or 747 may expose at least a portion of the tip portion of each of the protruding patterns 720. Referring to FIG. 12, the capping pattern 746 of the reflective member 706 may include a plurality of horizontal bar patterns arranged in rows parallel to each other. Referring to FIG. 13, the capping patterns 747 of the reflective member 707 may include a plurality of holes exposing a tip portion of each of the protruding patterns 720.

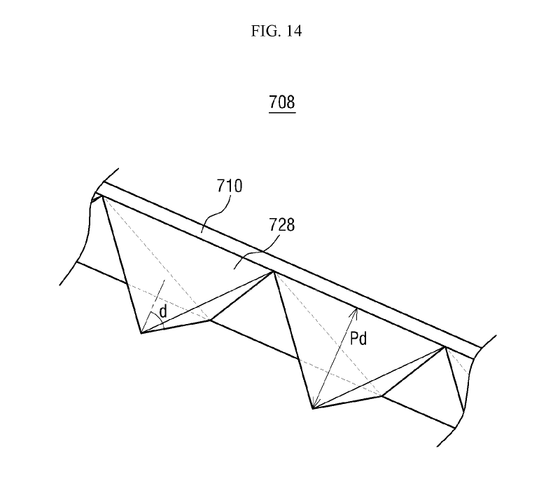

Referring to FIG. 14, a protruding distance Pd of each of a plurality of protruding patterns 728 of the reflective member 708 may be reduced toward the bottom thereof. That is, the protruding distance Pd of each of the protruding patterns 728 may be reduced toward the circuit board 510 or the reflective plate 800. In an exemplary embodiment, each of the protruding patterns 728 of the reflective member 708 may be shaped like, but is not limited to, an inverted pyramid. In the exemplary embodiment of FIG. 14, an angle d may have a value that is determined based on a maximum protruding distance b (see FIG. 6) and a height c (see FIG. 6) of each of the protruding patterns 728.

The protruding patterns 728 described above can be used when a lens of each of the light sources 520 facing the protruding patterns 728 is a top-emitting lens. That is, each of the light sources 520 including the top-emitting lens emits more light in an upward direction than in a lateral direction. Therefore, the protruding patterns 728, each having a greater protruding distance Pd in an upper part thereof than in a lower part thereof, can be used to diffuse light emitted in the upward direction.

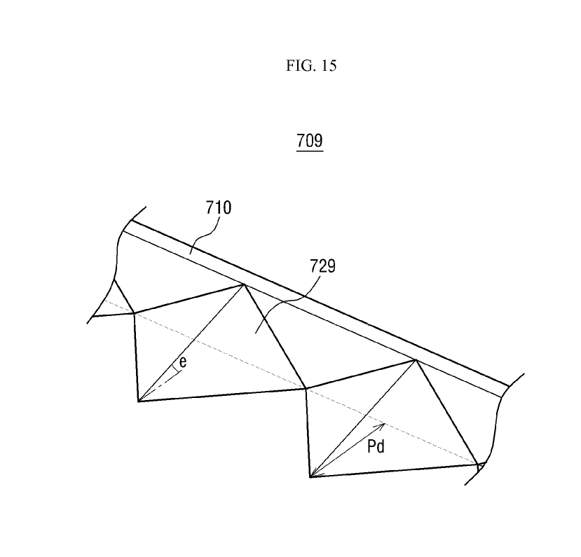

Referring to FIG. 15, a protruding distance Pd of each of a plurality of protruding patterns 729 of the reflective member 709 may be reduced toward the top thereof. That is, the protruding distance Pd of each of the protruding patterns 729 may be reduced toward the diffusion plate 600 or the display panel 200. In an exemplary embodiment, each of the protruding patterns 729 of the reflective member 709 may be shaped like, but is not limited to, a triangular pyramid. In the exemplary embodiment of FIG. 15, an angle e may have a value that is determined based on a maximum protruding distance b (see FIG. 6) and a height c (see FIG. 6) of each of the protruding patterns 729.

The protruding patterns 729 described above can be used when a lens of each of the light sources 520 facing the protruding patterns 729 is a side-emitting lens. That is, each of the light sources 520 including the side-emitting lens emits more light in a lateral direction than in an upward direction. Therefore, the protruding patterns 729, each having a greater protruding distance Pd in a lower part thereof than in an upper part thereof, can be used to diffuse light emitted in the lateral direction.

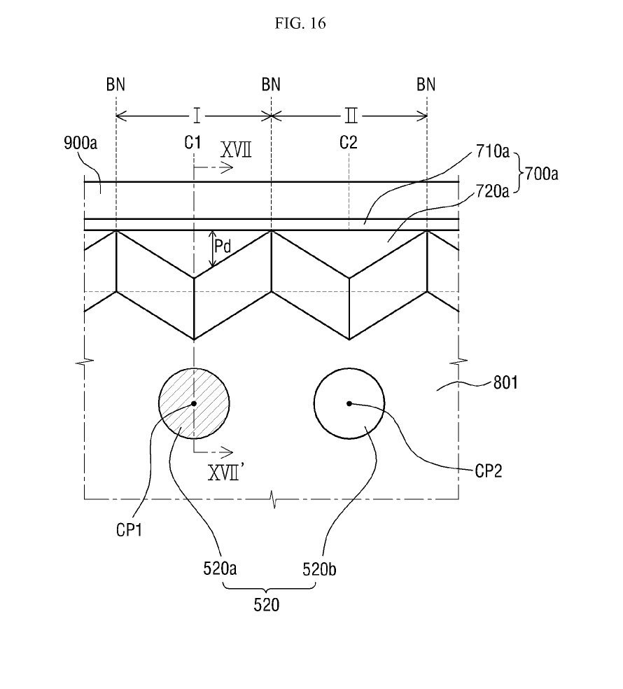

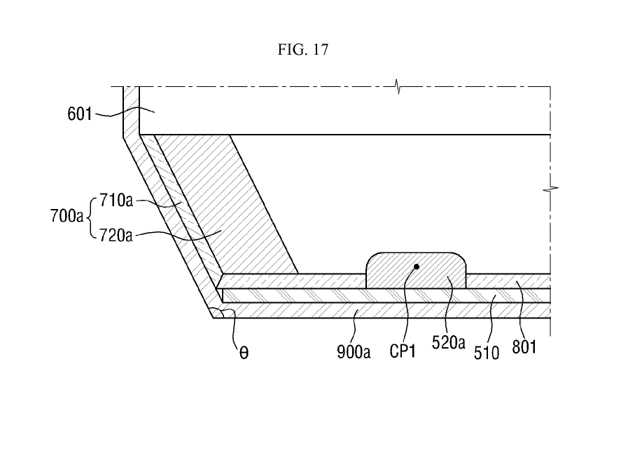

FIG. 16 is a plan view of a backlight assembly according to another embodiment of the inventive concept. FIG. 17 is a cross-sectional view taken along the line XVII-XVII′ of FIG. 16. For convenience of description, elements substantially similar to those illustrated in the above-described drawings are indicated by the same reference numerals, and thus a detailed description thereof will be omitted.

Referring to FIGS. 16 and 17, a sidewall of a bottom chassis 900a may slope at a predetermined angle θ. Accordingly, a reflective plate 801 and a diffusion plate 601 disposed on a lower surface of the bottom chassis 900a may be increased in size.

A reflective member 700a is disposed on an inner surface of the sidewall of the bottom chassis 900a. The reflective member 700a of FIGS. 16 and 17 may be similar to the reflective member 700 of FIG. 6. However, the reflective member 700a may slope at an angle corresponding to the angle θ of the sloping sidewall of the bottom chassis 900a. That is, a base layer 710a and a plurality of protruding patterns 720a of the reflective member 700a may slope at substantially a same angle as the angle θ at which the sidewall of the bottom chassis 900a slopes. Here, a cross-section of each of the protruding patterns 720a may be shaped like a parallelogram.

It should be noted that the shape of the reflective member 700a may be modified accordingly if the bottom chassis 900a having the sloping sidewall is used.

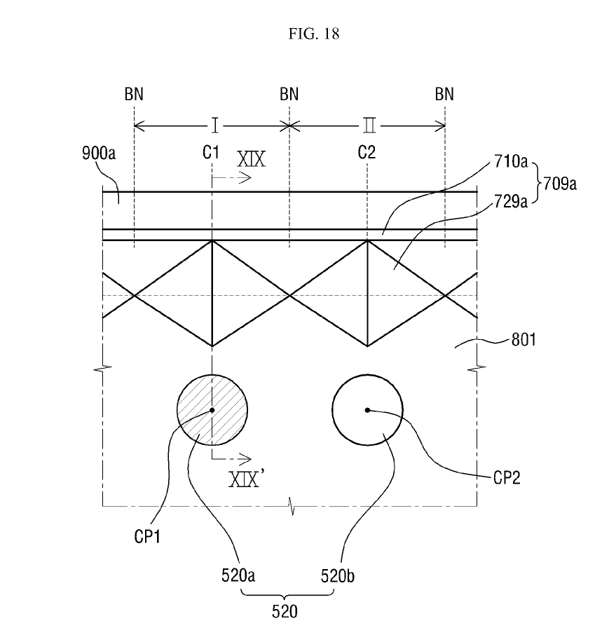

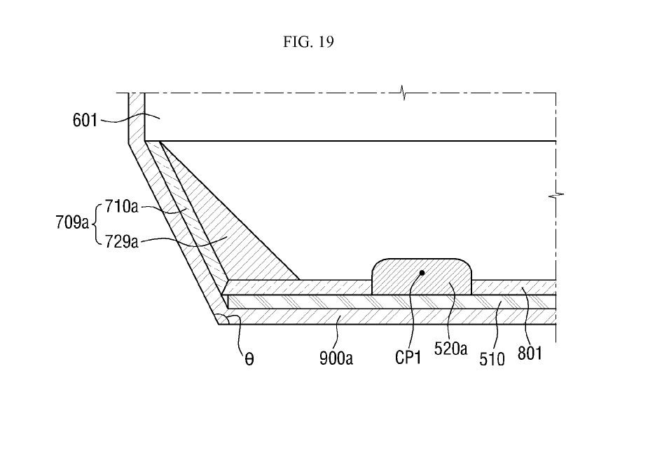

FIG. 18 is a plan view of a backlight assembly according to another embodiment of the inventive concept. FIG. 19 is a cross-sectional view taken along the line XIX-XIX′ of FIG. 18. For convenience of description, elements substantially similar to those illustrated in the above-described drawings are indicated by the same reference numerals, and thus a detailed description thereof will be omitted.

Referring to FIGS. 18 and 19, a reflective member 709a is disposed on an inner surface of a sidewall of a bottom chassis 900a. The reflective member 709a of FIGS. 18 and 19 may be similar to the reflective member 709 of FIG. 15. However, the reflective member 709a may slope at an angle corresponding to an angle θ at which the sidewall of the bottom chassis 900a slopes. That is, a base layer 710a and a plurality of protruding patterns 729a of the reflective member 709a may slope at substantially a same angle as the angle θ at which the sidewall of the bottom chassis 900a slopes. Here, a cross-section of each of the protruding patterns 729a may be shaped like a sloping triangle.

Using the above-described structures, light emitted from light sources 520 located at an edge portion ED can be delivered to an edge of a diffusion plate 601. Therefore, the display area of the display panel 200 can be increased (or the width of a bezel can be reduced).

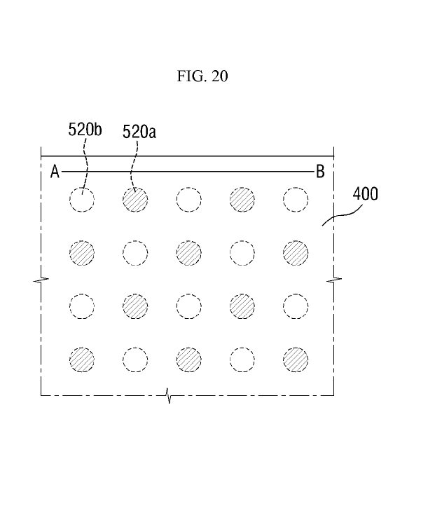

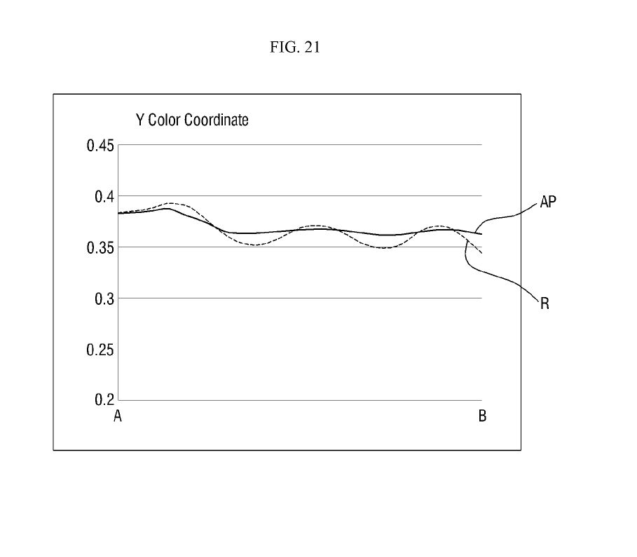

Next, the prevention of color stains using a display device employing the reflective member 700 according to an embodiment of the inventive concept will be described with reference to FIGS. 20 and 21. FIG. 20 is a plan view as seen from above an optical sheet 400 of a display device employing the reflective member 700 of FIG. 6 according to an embodiment of the inventive concept. FIG. 21 is a graph comparing the Y color coordinates in a portion A-B of FIG. 20 with and without the reflective member 700 of FIG. 6.

In the examples of FIGS. 20 and 21, each of a plurality of light sources 520 includes a top-emitting lens. In addition, a conventional diffuse reflective sheet is used as a reflective plate 800. Furthermore, a distance d1 (measured from each of a plurality of light sources 520 located at an edge portion ED of a light source unit 500 to a base layer 710) may be about 14.8 mm, a distance d2 (measured between two adjacent light sources 520 located at the edge portion ED of the light source unit 500) may be about 40.7 mm, and a distance d3 (measured from the reflective plate 800 to a diffusion plate 600) may be about 14.6 mm.

Also, a pitch a of adjacent protruding patterns 720 of the reflective member 700 may be about 40.7 mm which is equal to the distance d2 between two adjacent light sources 520 located at the edge portion ED of the light source unit 500. A maximum protruding distance b of each of the protruding patterns 720 may be about 5 mm, and a height c of each of the protruding patterns 720 may be about 14.6 mm which is equal to the distance d3 from the reflective plate 800 to the diffusion plate 600.

A Y color coordinate is then measured in the portion A-B of FIG. 20 from above the optical sheet 400. The graph of the Y color coordinate is illustrated in FIG. 21 for two cases: AP (display device including the reflective member 700) and R (display device without the reflective member 700). Referring to FIG. 21, the Y color coordinate graph (AP) indicates improved stability compared to the Y color coordinate graph (R). That is, the Y color coordinate in the portion A-B (in a display device including the reflective member 700) corresponds to substantially a Y color coordinate of a white color. In other words, hardly any color stain has occurred at the edge portion ED of the light source unit 500 using the reflective member 700 according to the inventive concept.

Embodiments of the inventive concept provide at least one of the following advantages.

That is, a reflective member including a plurality of protruding patterns is placed at an edge portion of a light source unit. Accordingly, color stains can be prevented from occurring at an edge portion of a display panel.

It should be noted that the above-described embodiments are merely illustrative and should not be construed as limiting the inventive concept. While the inventive concept has been described with reference to certain exemplary embodiments, it will be understood by those of ordinary skill in the art that various changes may be made to the described embodiments without departing from the spirit and scope of the present disclosure.

What is claimed is:

1. A backlight assembly comprising:
a light source unit comprising a plurality of light sources; and
a reflective member disposed adjacent to an edge portion of the light source unit,
wherein the reflective member comprises:
a base layer; and
a plurality of protruding patterns disposed on the base layer and facing the light source unit.

2. The backlight assembly of claim 1, wherein the protruding patterns are disposed corresponding to a plurality of light sources located at the edge portion of the light source unit.

3. The backlight assembly of claim 2, wherein the light sources comprise a first light source and a second light source, and
wherein light of a first color is emitted from the first light source and light of a second color is emitted from the second light source, and the first and second colors are complementary colors.

4. The backlight assembly of claim 3, wherein the first light source emits magenta light and the second light source emits green light.

5. The backlight assembly of claim 3, wherein the base layer comprises a first area facing the first light source and a second area facing the second light source, and wherein a protruding distance of each of the protruding patterns is reduced toward a boundary portion between the first area and the second area.

6. The backlight assembly of claim 5, wherein each of the protruding patterns has a maximum protruding distance in a central portion of each of the first area and the second area.

7. The backlight assembly of claim 2, wherein the protruding patterns protrude toward respective centers of the light sources corresponding to the protruding patterns.

8. The backlight assembly of claim 1, wherein the protruding patterns comprise a reflective material.

9. The backlight assembly of claim 1, wherein the reflective member further comprises a capping pattern disposed on a tip portion of each of the protruding patterns, and wherein the protruding patterns comprise a transparent material and the capping pattern comprises a reflective material.

10. The backlight assembly of claim 9, wherein the capping pattern exposes at least part of the tip portion of each of the protruding patterns.

11. The backlight assembly of claim 1, wherein the reflective member further comprises a plurality of uneven patterns disposed on each of the protruding patterns, and wherein the uneven patterns cover a surface of each of the protruding patterns.

12. The backlight assembly of claim 1, wherein the light source unit further comprises a circuit board on which the light sources are mounted, and wherein the protruding distance of each of the protruding patterns is reduced toward the circuit board.

13. The backlight assembly of claim 1, further comprising a diffusion plate disposed on the light source unit, and wherein the protruding distance of each of the protruding patterns is reduced toward the diffusion plate.

14. The backlight assembly of claim 1, further comprising a housing for supporting the light source unit and the reflective member, the housing comprising a sloping sidewall, and wherein the reflective member is disposed on an inner surface of the sloping sidewall and slopes according to the sloping sidewall.

15. A backlight assembly comprising:
a light source unit comprising a plurality of light sources, wherein the plurality of light sources comprise a first light source emitting light of a first color and a second light source emitting light of a second color, wherein the first and second colors are different; and
a reflective member disposed adjacent to an edge portion of the light source unit,
wherein the reflective member comprises:
a base layer comprising a first area facing the first light source and a second area facing the second light source; and
a plurality of protruding patterns disposed on the base layer,
wherein a protruding distance of each of the protruding patterns is reduced toward a boundary portion between the first area and the second area.

16. The backlight assembly of claim 15, wherein the first color and the second color are complementary colors.

17. The backlight assembly of claim 15, wherein each of the protruding patterns has a maximum protruding distance in a central portion of each of the first area and the second area.

18. A display device comprising:
a display panel for displaying an image; and
a backlight assembly for providing light to the display panel,
wherein the backlight assembly comprises:
a light source unit comprising a plurality of light sources; and
a reflective member disposed adjacent to an edge portion of the light source unit,
wherein the reflective member comprises:
a base layer; and
a plurality of protruding patterns disposed on the base layer and facing the light source unit.

19. The backlight assembly of claim 18, wherein the protruding patterns are disposed corresponding to a plurality of light sources located at the edge portion of the light source unit.

20. The backlight assembly of claim 18, wherein the light sources comprise a first light source and a second light source, wherein light of a first color is emitted from the first light source and light of a second color is emitted from the second light source, and the first and second colors are complementary colors.
